(19) United States
(12) Patent Application Publication
(10) Pub. No.: US 2026/0180400 A1
(43) Pub. Date: Jun. 25, 2026

(54) MOTOR, ELECTRIC DRIVE ASSEMBLY SYSTEM, VEHICLE AND METHOD FOR COOLING THE MOTOR

(71) Applicant: VALEO EAUTOMOTIVE GERMANY GMBH, Erlangen (DE)

(72) Inventors: Yawei SUN, Erlangen (DE); Yejin JIN, Erlangen (DE); Xing-Ang CHENG, Erlangen (DE); Joshua-Shu ZHANG, Erlangen (DE)

(73) Assignee: VALEO EAUTOMOTIVE GERMANY GMBH, Erlangen (DE)

(21) Appl. No.: 19/128,303

(22) PCT Filed: Nov. 8, 2023
(86) PCT No.: PCT/EP2023/081220

§ 371 Date: May 8, 2025

(30) Foreign Application Priority Data
Nov. 15, 2022 (CN) 202211429491.2

(51) Int. Cl. H02K 9/19; H02K 9/22

(52) U.S. Cl. CPC H02K 9/19; H02K 9/225

(57) ABSTRACT

A system and method for cooling the motor having a rotor with a rotor shaft that rotates around a rotation axis, a stator having a core and stator coils located at both axial ends of the core. The cooling system includes a fluid supply channel provided in the rotor shaft, a plurality of groups of fluid flow-out channels arranged on the rotor shaft and corresponding to the stator coil, and a fluid storage channel provided in fluid communication with the fluid supply channel and the fluid flow-out channels. The fluid supply channel is adjacent to at least one of the plurality of groups of fluid flow-out channels and at least partially extends into the fluid storage channel, so that the cooling fluid flowing out of the fluid supply channel enters the fluid storage channel and then flows out of the fluid flow-out channel to cool the stator coil.

### TECHNICAL FIELD

The present disclosure relates to a motor with a cooling system, an electric drive assembly system comprising such a motor, a vehicle comprising such an electric drive assembly system, and a method for cooling such a motor.

### BACKGROUND

A typical motor comprises a rotor and a stator, the rotor being rotatable with respect to the stator, and a motor may be an alternating current generator capable of operating in two modes, an electric motor, or an electric rotating machine in the form of a reversible motor.

A motor may generate a considerable amount of heat during operation, and overheating will cause the insulation performance of the motor windings to deteriorate rapidly. Another problem is that the permanent magnets in the rotor will lose their magnetic properties (becoming demagnetised) as they overheat, resulting in a loss of efficiency.

Therefore, cooling internal motor components (such as the rotor) and external motor components (such as the housing and the stator) is crucial to ensuring the proper operation of a motor and to increasing its power density and prolonging its service life.

### SUMMARY

To address the above problems and needs, the present disclosure proposes a novel motor, an electric drive assembly system, a vehicle, and a method for cooling the motor, which solves the above problems and produces other technical effects by adopting the following technical features.

In one aspect, the present disclosure provides a motor comprising a rotor, a stator, and a cooling system, with a rotor shaft that rotates around a rotation axis; the stator comprises a core and stator coils located at both axial ends of the core; the cooling system comprises a fluid supply channel provided in the rotor shaft; a plurality of groups of fluid flow-out channels arranged on the rotor shaft and corresponding to the stator coil; and a fluid storage channel provided at the middle part of the rotor shaft and in fluid communication with the fluid supply channel and the fluid flow-out channels,
wherein the fluid supply channel is adjacent to at least one of the plurality of groups of fluid flow-out channels and at least partially extends into the fluid storage channel, so that the cooling fluid flowing out of the fluid supply channel enters the fluid storage channel and then flows out of the fluid flow-out channel to cool the stator coil.

According to the above features, the fluid supply channel is arranged at a position adjacent to at least one of a plurality of groups of fluid flow-out channels and at least partially extends into the fluid storage channel, so the cooling fluid flowing out of the fluid supply channel enters the fluid storage channel, and the flow of the cooling fluid in the fluid storage channel cools the rotor shaft, thereby cooling the rotor. After the cooling fluid fills the fluid storage channel, it flows out of the fluid flow-out channels to cool the stator coil.

In addition, since the fluid supply channel at least partially extends into the fluid storage channel, the cooling fluid flowing out of the fluid supply channel is prevented from directly flowing out of the fluid flow-out channel and, instead, has to pass through the fluid storage channel and accordingly cool the rotor shaft before flowing out of the fluid flow-out channels.

The stator comprises a core and stator coils located at both axial ends of the core, wherein a stator coil is an important component of the stator, and for a motor, an increase in temperature of the stator coil (usually made of metal materials such as copper) can lead to a decrease in the efficiency of the motor. Therefore, ensuring that the temperature of the stator coils remains stable to avoid overheating is crucial for improving the efficiency of a motor.

Moreover, since the fluid supply channel is located adjacent to at least one of a plurality of groups of fluid flow-out channels and at least partially extends into the fluid storage channel, the cooling fluid flowing out of the fluid supply channel enters the fluid storage channel and flows along the axial direction of the fluid storage channel under the action of centrifugal force until it uniformly fills the fluid storage channel. Compared with other possible solutions in which the fluid supply channel is arranged at the middle part of the rotor shaft, resulting in uneven distribution of the cooling fluid from the middle to both sides, the above features proposed in the present disclosure can effectively solve this problem, because the cooling fluid flowing out of the fluid supply channel, after entering the fluid storage channel, flows along one side only, during which flow process, the cooling fluid is naturally evenly distributed until it fills the entire fluid storage channel, thus achieving a more uniform heat dissipation effect.

Further, the cooling fluid is oil for cooling the rotor and the stator during operation. Compared with thermal conduction using a conductive liquid, for example, water or ethylene glycol, to cool the outer housing of a motor, oil cooling allows the oil to directly enter the rotor and the stator for heat dissipation by thermal convection, thereby achieving a higher cooling efficiency.

In some embodiments, the plurality of groups of fluid flow-out channels comprises a first group of fluid flow-out channels and a second group of fluid flow-out channels, which are respectively arranged at the positions of the two ends of the rotor shaft corresponding to the stator coil.

According to the above features, the first group of fluid flow-out channels and the second group of fluid flow-out channels are respectively set arranged at the positions of the two ends of the rotor shaft corresponding to the stator coil, so that the cooling fluid that has flowed out enters the stator coil more directly and cools it. Optionally, the inner wall of the first group of fluid flow-out channels and that of the second group of fluid flow-out channels may have substantially the same inner diameters.

In some embodiments, the rotor shaft comprises a hollow cylindrical body, and a first part and a second part on both sides of the cylindrical body, wherein the cylindrical body comprises an inner wall, an outer wall, and the plurality of groups of fluid flow-out channels throughout the inner wall and the outer wall; and the inner wall between the first group of fluid flow-out channels and the second group of fluid flow-out channels is provided with a groove portion to form the fluid storage channel; wherein the fluid supply channel is inserted into the first part and at least partially extends beyond the first group of fluid flow-out channels in the direction of the rotation axis, so as to enter the fluid storage channel.

According to the above feature, the inner diameter of the inner wall between the first group of fluid flow-out channels and the second group of fluid flow-out channels is greater than the inner diameter of the first group of fluid flow-out channels and the second group of fluid flow-out channels, which means that the inner wall between the two fluid flow-out channels is provided with a groove portion to form the storage channel for cooling fluid.

In some embodiments, the fluid supply channel extends in the direction of the rotation axis no more than ⅓ of the length of the cylindrical body.

According to the above feature and in combination with the feature of having the fluid supply channel adjacent to at least one of the plurality of groups of fluid flow-out channels, to ensure a uniform distribution of the cooling fluid in the fluid storage channel, the fluid supply channel should be located close to the end of the rotor shaft, that is, it extends no more than ⅓ of the length of the cylindrical body. In a substitute embodiment, the fluid supply channel extends in the direction of the rotation axis no more than ¼, ⅕, ⅙, or less of the length of the cylindrical body, or extends no more than ⅓ to ½ of the length of the cylindrical body.

In some embodiments, the inlets of the first and/or second group of fluid flow-out channels are radially inward with respect to the inner wall between the first and second group of fluid flow-out channels.

According to the above characteristic, the inner diameter of the inlets of the first group of fluid flow-out channels and/or the second group of fluid flow-out channels is smaller than the inner diameter of the fluid storage channel, which means that a groove portion is formed on the inner wall between the inlets of the two fluid flow-out channels to form the storage channel for cooling fluid.

In some embodiments, a step is provided on the inner wall of the cylindrical body between the first group of fluid flow-out channels and the second group of fluid flow-out channels, and close to the first group of fluid flow-out channels and the second group of fluid flow-out channels, respectively, to form the groove portion.

According to the above characteristic, a step is provided at corresponding positions to form a step changing part between the fluid storage channel and the fluid flow-out channels, wherein the height of the step corresponds to the depth of the groove portion, and the surface between the step and the inlets of the fluid flow-out channels may extend parallel to the axial direction, so that the cooling fluid overflowing from the fluid storage channel flows towards the inlets of the fluid flow-out channels substantially in the axial direction.

In some embodiments, the inner wall of the cylindrical body at the first group of fluid flow-out channels and the second group of fluid flow-out channels is an inclined surface.

According to the above characteristic, the inner wall of the cylindrical body at the first group of fluid flow-out channels and the second group of fluid flow-out channels may be arranged as an inclined surface, which is directly connectible with the inlets of the first group of fluid flow-out channels and the second group of fluid flow-out channels, allowing the cooling fluid overflowing from the fluid storage channel to flow out directly of the inlets of the fluid flow-out channels.

In some embodiments, the first group of fluid flow-out channels and/or the second group of fluid flow-out channels extend at an angle with respect to the rotation axis.

According to the above characteristic, the first group of fluid flow-out channels and/or the second group of fluid flow-out channels extend at an angle with respect to the rotation axis, the angle being in the range of 0 degrees to 90 degrees (inclusive of endpoints). At an angle of 0 degrees, the first group of fluid flow-out channels and/or the second group of fluid flow-out channels are parallel to the rotation axis, and at an angle of 90 degrees, the first group of fluid flow-out channels and/or the second group of fluid flow-out channels are perpendicular to the rotation axis. At an angle of greater than 0 degrees and smaller than 90 degrees, the first group of fluid flow-out channels and/or the second group of fluid flow-out channels are inclined with respect to the rotation axis, and the cooling fluid flows out through the inclined fluid flow-out channels.

When the rotor shaft is operating, that is, rotating around the rotation axis, the cooling fluid having flowed into the fluid flow-out channels flows out along the fluid flow-out channels under the action of centrifugal force, wherein, by adjusting the inclination angle of the fluid flow-out channels, the component of centrifugal force in the extension direction of the fluid flow-out channels is adjustable accordingly, which allows adjusting the flow rate of cooling fluid ejected or thrown out of the fluid flow-out channel.

In addition, in the analysis from another perspective, the inclination angle of the fluid flow-out channels may also have an influence on the coverage area of the cooling fluid at the inlets of the fluid flow-out channels, thereby affecting the amount of liquid flowing out. For example, when the liquid level in the rotor shaft is low, the area of the fluid coverage hole is small, and the amount of liquid thrown out is small; when the liquid level in the rotor shaft is high, the area of the fluid coverage hole is large, and the amount of liquid thrown out is large.

In some embodiments, the first group of fluid flow-out channels comprises a plurality of first guide holes adjacent to the first part, the second group of fluid flow-out channels comprises a plurality of second guide holes adjacent to the second part, and the first guide holes and/or the second guide holes are circumferentially arranged along the rotor shaft.

According to the above characteristic, the fluid flow-out channels may take the form of guide holes, which are circumferentially arranged along the rotor shaft and at least partially throughout the inner wall of the rotor shaft, thereby allowing the cooling fluid of the fluid storage channel in the hollow rotor shaft to flow out. Alternatively, the fluid flow-out channels may also take other forms, for example, allowing the fluid to flow out of a conduit.

In some embodiments, the first guide holes and/or the second guide holes extend in a radial direction perpendicular to the rotation axis.

In some embodiments, the first guide holes and/or the second guide holes extend at an angle to the radial direction perpendicular to the rotation axis.

Similar to the above embodiments, guide holes that extend at an angle can adjust the rate and volume at which the cooling fluid flows out, thereby improving the flexibility and design margin of the cooling system. The number of the first guide holes and/or second guide holes may be in the range of 2 to 10, for example 2 to 6.

In another aspect, the present disclosure provides an electric drive assembly system, comprising a housing and a motor as described above, wherein the rotor shaft is supported in the housing by at least one bearing.

In some embodiments, the electric drive assembly system further comprises a gear shaft rotationally fixedly connected with the rotor shaft, the gear shaft comprising a first end and a second end opposite to each other, and a fluid channel throughout the first and second ends, wherein the second end is formed as the fluid supply channel.

Optionally, the gear shaft may be fixedly connected with the rotor shaft through splines.

In some embodiments, the electric drive assembly system further comprises a nozzle arranged at the first end which is in fluid communication with the fluid channel, and the nozzle is in clearance fit with the fluid channel.

According to the above characteristic, the nozzle may be in fluid communication with the fluid channel, and the cooling fluid may be pumped into the fluid channel through the nozzle, before finally entering the fluid supply channel.

In some embodiments, at the outlet of the nozzle, the fluid channel is provided with a stepped hole, and an inner diameter of the stepped hole is smaller than a radial dimension of the fluid channel and larger than an inner diameter of the nozzle orifice.

In an embodiments, the nozzle is in clearance fit with the fluid channel, so a small amount of cooling fluid may leak through the clearance in the clearance fit. In order to prevent such leakage, according to the above characteristic, a stepped hole is arranged in the fluid channel at the outlet of the nozzle, which can block the cooling fluid and prevent the cooling fluid from flowing back and leaking through the clearance.

In some embodiments, the electric drive assembly system further comprises a bearing support structure for the rotor shaft and the gear shaft, wherein the bearing support structure comprises: a first bearing supporting the gear shaft at the first end; a second bearing supporting the rotor shaft at the first part; and a third bearing supporting the rotor shaft at the second part.

According to the above characteristic, better support may be provided for the gear shaft, and the bearing support structure can provide sufficient support in the electric drive assembly system, while preventing movement between the gear shaft and rotor shaft, which improves the NVH performance of the entire vehicle.

In another aspect, the present disclosure further proposes a vehicle comprising an electric drive assembly system as described above.

In yet another aspect, the present disclosure further proposes a method for cooling a motor, the method comprising: cooling a stator coil by a cooling system to supply fluid to the stator coil of a stator via a rotor shaft of a rotor, wherein the cooling system comprises a fluid supply channel arranged in the rotor shaft; a plurality of groups of fluid flow-out channels arranged on the rotor shaft and corresponding to the stator coil; and a fluid storage channel provided at the middle part of the rotor shaft and in fluid communication with the fluid supply channel and the fluid flow-out channels, wherein the fluid supply channel is adjacent to at least one of the plurality of groups of fluid flow-out channels, and at least partially extends into the fluid storage channel, so that the cooling fluid flowing out of the fluid supply channel enters the fluid storage channel, and after the cooling fluid fills the fluid storage channel, it flows out of the fluid flow-out channels to cool the stator coil.

In some embodiments, the plurality of groups of fluid flow-out channels comprises a first group of fluid flow-out channels and a second group of fluid flow-out channels, which are respectively arranged at the positions of both ends of the rotor shaft corresponding to the stator coil; the first group of fluid flow-out channels and/or the second group of fluid flow-out channels extend at an angle relative to the rotation axis of the rotor shaft.

In some embodiments, an inner wall between the first group of fluid flow-out channels and the second group of fluid flow-out channels is provided with a groove portion to form the fluid storage channel.

According to the above characteristic, the present disclosure further proposes a method for cooling a motor on the basis of the proposed motor structure, which allows cooling both the stator coil and the rotor during the operation of the motor through the flow of a cooling fluid.

### BRIEF DESCRIPTION OF THE DRAWINGS

In order to give a clearer explanation of the technical solutions provided by some embodiments of the present disclosure, the drawings of the embodiments will be briefly described below, wherein it is evident that the drawings in the following description only relate to some embodiments of the present disclosure, rather than limiting the present disclosure.

FIG. 1 is a schematic diagram of a motor according to at least one embodiment of the present disclosure;

FIG. 2 is a schematic diagram of an electric drive assembly system according to at least one embodiment of the present disclosure;

FIG. 3 is a schematic diagram of the flow of cooling fluid from the fluid supply channel flowing out of the fluid flow-out channels through the fluid storage channel;

FIG. 4 to FIG. 8 are schematic diagrams of an electric drive assembly system according to one or more embodiments of the present disclosure;

FIG. 9 is a flowchart of a method for cooling a motor according to at least one embodiment of the present disclosure.

### DETAILED DESCRIPTION

In order to make clearer the objectives, technical solutions and advantages of the present disclosure, technical solutions provided by some embodiments of the present disclosure will be clearly and completely described below with reference to the drawings of specific embodiments of the present disclosure. In the drawings, identical reference numerals denote identical parts. It is important to note that the embodiments described are only some embodiments of the present disclosure and are not all embodiments. All other embodiments obtained by those of ordinary skill in the art based on the described embodiments of the present disclosure without any creative work fall within the scope of protection of the present disclosure.

Unless otherwise defined, technical or scientific terms used herein shall have ordinary meanings as understood by those of ordinary skill in the art to which this disclosure belongs. “First”, “second” and similar words used in the description and claims of the patent application of the present disclosure do not indicate any order, quantity or importance, being merely used to distinguish between different component parts. Likewise, words such as “a” or “one” do not necessarily represent a quantity limit. “Comprise”, “include”, or any other similar term means that the element or object appearing before the term covers the elements or objects and equivalents thereof listed after the term but does not exclude other elements or objects. “Connected” or “coupled” and similar words are not limited to a physical or mechanical connection, and may include an electrical connection, whether direct or indirect. “Upper”, “lower”, “left”, “right”, etc., are only used to indicate a relative positional relationship, and when the absolute position of the described object changes, the relative positional relationship might also change accordingly.

A typical motor comprises a rotor and a stator, and a motor may be an alternating current generator capable of operating in two modes, an electric motor, or an electric rotating machine in the form of a reversible motor. Electronic components of vehicles, especially those of electric vehicles, are powered by batteries, and electric vehicles are driven by drive motors. An electric vehicle comprises large numbers of other components, which are not described herein but are known to those of ordinary skill in the art. Further, different types of vehicles, including motorcycles, planes, trucks, ships, and train engines, are combinable with the inventive concepts described herein.

When operating properly, a motor generates a considerable amount of heat, which, if not dissipated in a timely manner, can cause the motor to overheat. When a motor overheats, the insulation performance of the motor windings deteriorates rapidly, which affects the safety and service life of the motor, and, moreover, the permanent magnets in the rotor lose their magnetic properties as they overheat, which results in a loss of efficiency. Therefore, it is necessary to cool the internal components (such as the rotor) and external components (such as the housing and the stator) of a motor.

Several different approaches have been developed to meet the cooling needs of vehicle motors. For example, a cooling circuit is formed by feeding a cooling pipe into the rotor shaft and the stator, and a coolant, for example, oil, is typically used in this method. However, the component structure of such a cooling circuit is usually complex.

In addition, liquids such as water or ethylene glycol may be used for cooling, and, as such a liquid is conductive and cannot be directly introduced into the stator of a motor (otherwise a short circuit will occur), it may be used for cooling only outside the motor housing through thermal conduction.

To overcome the shortcomings of the prior art, the present disclosure provides a novel motor with a cooling system, an electric drive assembly system, a vehicle, and a method for cooling the motor, which has a simple structure and a high heat dissipation efficiency, thereby increasing the power density and prolonging the service life so that the permanent magnets become cooler and less likely to be demagnetised.

Electrification has become one of the major development trends in the automotive industry, and special attention has been paid to whether electric drive assembly systems, which function as the power systems of electric vehicles, are highly integrated, lightweight, and reliable.

An electric drive assembly system is a highly integrated electric drive system, usually composed of a motor, an inverter, and a retarder. The motor, inverter, and retarder of an electric drive system available on the current market are usually manufactured separately, with the motor, retarder, and inverter being connected with one another through fasteners, wherein, due to such a separate arrangement, the electric drive assembly system is large and heavy, taking a substantial space in the overall layout of the vehicle.

Therefore, the present disclosure further proposes a highly integrated electric drive assembly system based on the motor described above.

Embodiments according to the present disclosure are described in detail with reference to the drawings. It should be noted that in the drawings, identical reference signs are assigned to components that have substantially the same or similar structures and functions, and any repeated descriptions about them will be omitted.

Compared with the embodiments shown in the drawings, a feasible embodiment within the scope of protection of the present disclosure may have fewer components, another component not shown in any of the drawings, a different component, a component arranged differently, or a component connected differently, etc. Further, without departing from the concepts disclosed in the present disclosure, two or more components in a drawing may be implemented in a single component, or a single component shown in a drawing may be implemented as a plurality of separate components.

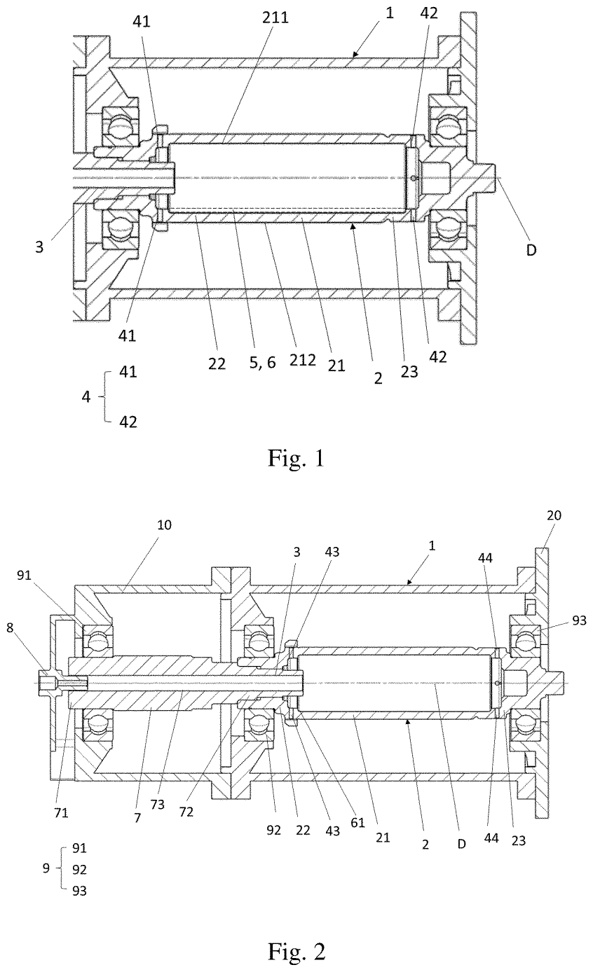

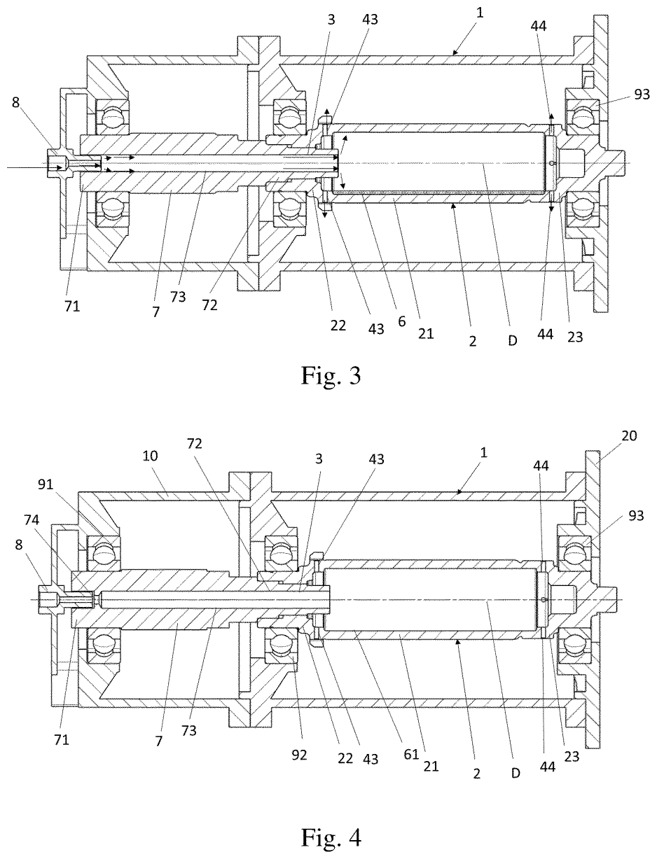

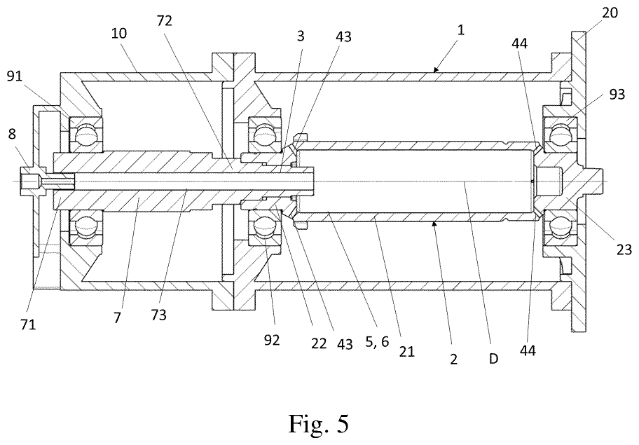

FIG. 1 is a schematic diagram of a motor according to at least one embodiment of the present disclosure. FIG. 2 is a schematic diagram of an electric drive assembly system according to at least one embodiment of the present disclosure. FIG. 3 is a schematic diagram of the flow of cooling fluid from the fluid supply channel flowing out of the fluid flow-out channels through the fluid storage channel.

As shown in FIG. 1, the motor may comprise a rotor and a stator, the rotor being rotatable with respect to the stator around a rotation axis. The rotor has a rotor shaft 2 that rotates around the rotation axis D. The stator comprises a core and stator coils (not shown in the drawing) located at both axial ends of the core. In the case the motor operates as an electric motor, the stator coil is energised to generate a driving magnetic field, which drives the rotor shaft 2 to rotate. Conversely, in the case the motor operates as a generator, the rotor shaft 2 is driven to rotate, thereby generating an induced current in the stator coil. In either case, the motor generates a considerable amount of heat during operation due to the driving current and the induced current, and the heat needs to be dissipated in a timely manner.

Therefore, a motor proposed in the present disclosure comprises a cooling system, the cooling system at least comprising a fluid circuit, in which heat is absorbed by cooling fluid and dissipated through a cooling circuit. In the embodiment shown, the cooling fluid is oil, for example, automatic transmission oil, lubricating oil, or any other similar oil. In another embodiment, another type of fluid may be used. In one example, the cooling system may further comprise a fluid pump, which pumps cooling fluid to the fluid circuit. In another example, the cooling system may, instead of comprising any pumps, use gears to stir oil, which then flows into the fluid channel through a conduit in the housing.

The cooling system specifically comprises a fluid supply channel 3, a plurality of groups of fluid flow-out channels 4, and a fluid storage channel 5. The fluid supply channel 3 is located in the rotor shaft 2, wherein the rotor shaft 2 is hollow and, as shown in FIG. 1, is closed at one end and open at the other end, into which the fluid supply channel 3 may extend. The fluid supply channel 3 may be, for example, a part of the gear shaft 7 of the electric drive assembly system (to be described in detail later), or it may be a fluid conduit extending into the rotor shaft 2.

A plurality of groups of fluid flow-out channels 4 are arranged on the rotor shaft 2 and correspond to the stator coils. In this embodiment, the plurality of groups of fluid flow-out channels 4 comprises a first group of fluid flow-out channels 41 and a second group of fluid flow-out channels 42, which are respectively arranged at the positions of the two ends of the rotor shaft 2 corresponding to the stator coil. The fluid flow-out channels 4 may be arranged throughout the rotor shaft 2. As shown in FIG. 1, the rotor shaft 2 comprises a hollow cylindrical body 21, as well as a first part 22 and a second part 23 on both sides of the cylindrical body 21. The first part 22 may be at least partially open, and the second part 23 may be closed. Alternatively, both the first part 22 and the second part 23 may be partially open to facilitate the introduction and flow-out of cooling fluid. The cylindrical body 21 comprises an inner wall 211, an outer wall 212, and a plurality of groups of fluid flow-out channels 4, the plurality of groups of fluid flow-out channels 4 being arranged throughout the inner wall 211 and the outer wall 212, for example, in the form of through holes.

The fluid storage channel 5 is arranged at the middle part of the rotor shaft 2 and is in fluid communication with the fluid supply channel 3 and the fluid flow-out channels 4. As shown in FIG. 1, the inner wall 211 between the first group of fluid flow-out channels 41 and the second group of fluid flow-out channels 42 is provided with a groove portion 6 to form the fluid storage channel 5. Specifically, the inner diameter of the inner wall 211 between the first group of fluid flow-out channels 41 and the second group of fluid flow-out channels 42 is greater than the inner diameter of the inner wall 211 of the cylindrical body 21 at the inlets of the first group of fluid flow-out channels 41 or the second group of fluid flow-out channels 42. In other words, the inlets of the first group of fluid flow-out channels 41 and/or the second group of fluid flow-out channels 42 are radially inward with respect to the inner wall 211 between the first group of fluid flow-out channels 41 and the second group of fluid flow-out channels 42. The height of the fluid storage channel 5 is equal to a difference between said inner diameters.

The fluid supply channel 3 is adjacent to at least one of the plurality of groups of fluid flow-out channels 4 and at least partially extends into the fluid storage channel 5, so that the cooling fluid flowing out of the fluid supply channel 3 enters the fluid storage channel 5, and then flows out of the fluid flow-out channels 4 to cool the stator coil. As shown in FIG. 1, the fluid supply channel 3 is adjacent to the first group of fluid flow-out channels 41.

It should be noted that the term “adjacent to” as used in the present disclosure refers to being close to or near, and, in terms of numerical definition, “adjacent to” may mean that the fluid supply channel 3 extends in the direction of the rotation axis D no more than ⅓, for example no more than ¼, ⅕, ⅙, or less, of the length of the cylindrical body 21.

Optionally, the number of the fluid flow-out channels 4 in each group may be in the range of 2 to 10, for example 2 to 6.

Again referring to FIG. 1, the fluid supply channel 3 is inserted into the first part 22 of the rotor shaft 2 and at least partially extends beyond the first group of fluid flow-out channels 41 in the direction of the rotation axis D, so as to enter the fluid storage channel 5. The fluid supply channel 3 may be a part of the gear shaft, which will be described in detail later.

A step 61 may be provided on the inner wall 211 of the cylindrical body 21 between the first group of fluid flow-out channels 41 and the second group of fluid flow-out channels 42, and close to the first group of fluid flow-out channels 41 and the second group of fluid flow-out channels 42, respectively, to form the groove portion 6. The step 61 is formed with a step change in radial dimension. Further, referring to FIG. 1 and FIG. 2 together, the first group of fluid flow-out channels 41 may comprise a plurality of first guide holes 43 adjacent to the first part 22, the second group of fluid flow-out channels 42 may comprise a plurality of second guide holes 44 adjacent to the second part 23, and a plurality of first guide holes 43 and a plurality of second guide holes 44 are circumferentially arranged along the rotor shaft 2, which may number 6 respectively and be distributed circumferentially in a uniform manner. Moreover, the first guide holes 43 and the second guide holes 44 extend in a radial direction perpendicular to the rotation axis D. Therefore, when the rotor shaft 2 rotates, a cooling fluid is ejected out of the first guide holes 43 and the second guide holes 44 under the action of centrifugal force to cool the stator coil. The cooling fluid, having cooled the stator coil, may be returned to a fluid pump or heat exchanger (not shown) through a recovery channel (not shown) arranged in the motor, thereby forming a fluid circuit.

As shown in FIG. 2, the electric drive assembly system may comprise a housing 1, a first end cover 10, a second end cover 20, a gear shaft 7, a nozzle 8, and a motor as described above, wherein the rotor shaft 2 of the motor is supported in the housing 1 by a bearing support structure 9. The first end cover 10 and the second end cover 20 fit the housing 1 respectively and are arranged opposite to each other.

The gear shaft 7 is rotationally fixedly connected with the rotor shaft 2 (for example, through a spline connection). The gear shaft 7 comprises a first end 71 and a second end 72 opposite to each other, and a fluid channel 73 throughout the first end 71 and the second end 72. Therefore, the gear shaft 7 is also a hollow structure, and the second end 72 is formed as a fluid supply channel 3, which extends into the rotor shaft 2 to communicate with the fluid storage channel 5.

The gear shaft 7 may be connected with a retarder and/or output shaft, thereby reducing the torque of the rotor shaft 2 and outputting it to drive the vehicle.

A nozzle 8 is arranged at the first end 71 of the gear shaft 7 and is in fluid communication with the fluid channel 73, wherein the cooling fluid enters the fluid channel 73 through the nozzle 8 and finally enters the fluid supply channel 3. The nozzle 8 may be arranged on the first end cover 10, substantially cylindrical in shape, and coaxial with the gear shaft 7 and the rotor shaft 2. The nozzle 8 is in clearance fit with the fluid channel 73, because when the motor is operating, the rotor shaft 2 and the gear shaft 7 rotate, while the nozzle 8 is in an idle state. Therefore, a small amount of cooling fluid may leak through the clearance in the clearance fit. Leaked cooling fluid is recoverable through a return channel (not shown) arranged in the housing 1, without affecting the operation of any other component in the electric drive assembly system.

The nozzle 8 may be connected with a fluid pump (not shown), so that cooling fluid may be pumped into the nozzle 8. Alternatively, oil may also be stirred by gears and flow into the fluid channel 73 through a conduit in the housing.

Referring again to FIG. 2, the bearing support structure 9 comprises at least a first bearing 91, a second bearing 92, and a third bearing 93.

The first bearing 91 supports the gear shaft 7 at the first end 71, and the first bearing 91 is mounted in the first end cover 10. The second bearing 92 supports the rotor shaft 2 at the first part 22, and the second bearing 92 is mounted in the housing 1. The third bearing 93 supports the rotor shaft 2 at the second part 23, and the third bearing 93 is mounted in the second end cover 20. Alternatively, the second bearing 92 may, instead of supporting the first part 22 of the rotor shaft 2, support the second end 72 of the gear shaft 7.

In this embodiment, the first end cover 10 and the second end cover 20 fit the housing 1 respectively and are arranged opposite to each other, wherein the first end cover 10 and the second end cover 20 respectively close the two end faces of the housing 1, and the motor and the gear shaft 7 share the same housing, without the need for an additional motor housing and/or gear housing.

Therefore, one housing 1 shared by the motor and the gear shaft is used, the gear shaft 7 is connected with the rotor shaft 2 through splines, and the gear shaft 7 and the rotor shaft 2 are supported by three bearings, which establishes a secure connection between the rotor shaft 2 and the gear shaft 7 to improve the power transmission efficiency, while reducing the weight and overall dimensions of the electric drive assembly system and providing better support for the gear shaft 7, and therefore, a support structure comprising at least three bearings can provide sufficient support in the electric drive assembly system while preventing movement between the two shafts.

Alternatively, the housing 1 may be formed by connecting two separate housings. For example, the motor housing and the gear housing may be two separate housings, with the motor housing and the gear housing being fixedly connected to each other by screws.

Alternatively, the bearing support structure may comprise more than three, for example, four, bearings. Two of the bearings support both ends of the rotor shaft 2 in the area where the motor is located, and the other two bearings support both ends of the gear shaft 7 in the area where the gear is located.

FIG. 3 is a schematic diagram of the flow of the cooling fluid in this embodiment. As indicated by the arrows in FIG. 3, the cooling fluid, driven by, for example, a fluid pump (not shown), first enters the fluid channel 73 from the nozzle 8. Under the combined action of the centrifugal force and the fluid pump, the cooling fluid flows substantially along the inner wall of the fluid channel 73 towards the fluid supply channel 3, and enters, from one side of the first part 22, the fluid storage channel 5, that is, the groove portion 6, where it accumulates and is evenly distributed in the groove portion 6, thereby cooling the rotor shaft 2. When the accumulated cooling fluid has filled the groove portion 6, the cooling fluid flows to the first guide holes 43 and the second guide holes 44, and under the action of centrifugal force, is ejected radially from the first guide holes 43 and the second guide holes 44, ultimately cooling the stator coil (not shown).

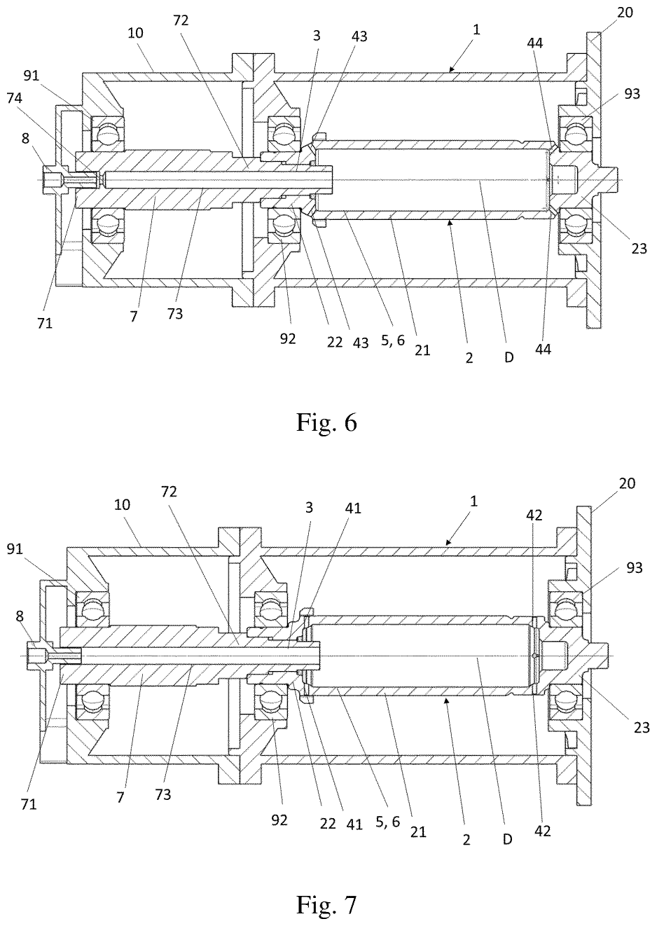

A motor according to at least one embodiment of the present disclosure and an electric drive assembly system comprising such a motor have been described above in conjunction with FIG. 1 to FIG. 3. On the basis of the inventive concept introduced by the present disclosure, variant embodiments are derivable, without exceeding the scope of the present disclosure. FIG. 4 to FIG. 8 are schematic diagrams of an electric drive assembly system according to one or more embodiments of the present disclosure.

For the sake of simplicity, in the following embodiments, special stress will be placed on describing their differences from the aforementioned embodiments, where identical components or features are denoted by identical or similar reference signs.

As shown in FIG. 4, in an exemplary embodiment, in order to avoid leakage of cooling fluid, the fluid channel 73 may further be provided with a stepped hole 74 at the outlet of the nozzle 8. The inner diameter of the stepped hole 74 is smaller than a radial dimension of the fluid channel 73 and larger than the inner diameter of the nozzle 8. Therefore, the cooling fluid entering the fluid channel 73 from the nozzle 8 cannot return to the parts that are in clearance fit, which prevents the cooling fluid from leaking through the clearance.

As shown in FIG. 5, in another exemplary embodiment, a plurality of first guide holes 43 and a plurality of second guide holes 44 extend at an angle to the radial direction, which is an acute angle, namely being greater than 0 degrees and smaller than 90 degrees. The cooling fluid flows out of the inclined first guide holes 43 and second guide holes 44. By adjusting the inclination angle of the first guide holes 43 and the second guide holes 44, the component of centrifugal force in the extension direction of the first guide holes 43 and the second guide holes 44 is adjustable accordingly, which allows adjusting the flow rate of cooling fluid ejected or thrown out of the first guide holes 43 and the second guide holes 44. The inclination angle of the first guide holes 43 and the second guide holes 44 also have an influence on the coverage area of the cooling fluid at the inlets of the fluid flow-out channels 4, thereby affecting the amount of liquid flowing out.

In conjunction with the features of the embodiments shown in FIG. 4 and FIG. 5, as shown in FIG. 6, this embodiment has both the features of the stepped hole 74 described above and the features of the inclined first guide holes 43 and second guide holes 44, thus providing the advantages of both embodiments described above.

As shown in FIG. 7, in yet another exemplary embodiment, the inner wall 211 of the cylindrical body 21 at the first group of fluid flow-out channels 41 and the second group of fluid flow-out channels 42 is an inclined surface. The inclined surface may be directly connected with the inlets of the first group of fluid flow-out channels 41 and the second group of fluid flow-out channels 42, allowing the cooling fluid overflowing from the fluid storage channel 5 to flow out directly from the inlets of the fluid flow-out channels, without the need to process any steps. The inclined surface may be formed, for example, by a chamfering process.

In the embodiment shown in FIG. 8, the feature of the stepped hole 74 as described above is added on the basis of the embodiment shown in FIG. 7, which will not be described again.

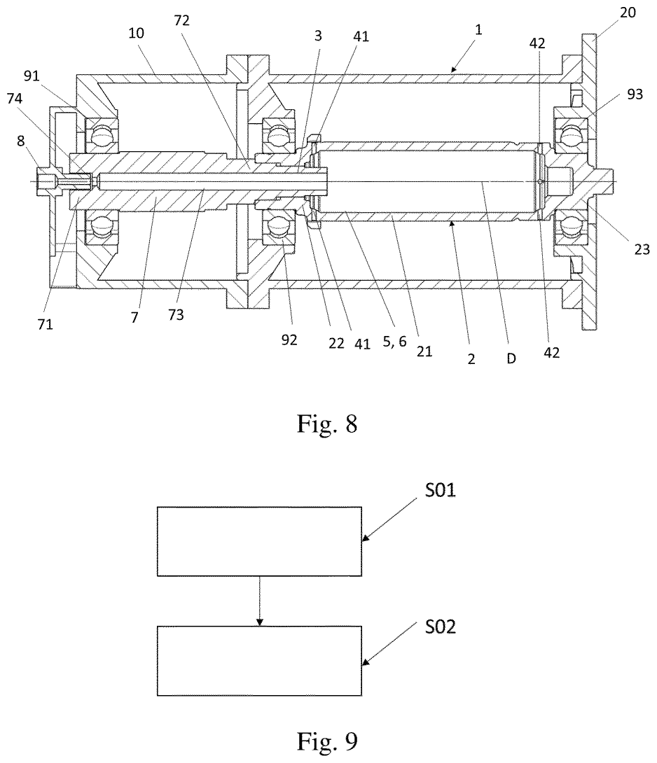

FIG. 9 is a flowchart of a method for cooling a motor. Firstly, in step S01, the motor is started and then the cooling system is started. Optionally, if a fluid pump is provided, the fluid pump may also be started in step S01. Then, in step S02, the fluid is supplied by the cooling system to the stator coils of the stator through the rotor shaft 2 of the rotor to cool the stator coils. A motor for implementing the above steps may comprise features in one or more embodiments as described above. According to another aspect of the present disclosure, a vehicle is further proposed. The vehicle for example comprises the electric drive assembly system described above.

The vehicle is for example a pure electric vehicle (BEV, Battery Electric Vehicle), a hybrid vehicle (HEV, Hybrid Electric Vehicle), a plug-in hybrid vehicle (PHEV, Plug-in Hybrid Electric Vehicle), a range extended electric vehicle (range extended electric vehicle), a fuel cell vehicle (FCEV, Fuel Cell Electric Vehicle), etc.

While exemplary embodiments of a motor, an electric drive assembly system, a vehicle, and a method for cooling the motor proposed in the present disclosure have been particularly described above with reference to preferred embodiments, those of ordinary skill in the art can understand that variations and modifications may be made to the above specific embodiments without departing from the spirit of the present disclosure. In addition, various technical features and structures proposed in various aspects of the present disclosure are combinable in various manners without exceeding the scope of protection of the present disclosure, which is defined by the attached claims.

1. A motor, comprising:
a rotor comprising a rotor shaft that rotates around the rotation axis;
a stator comprising a core and stator coil located at both axial ends of the core; and
a cooling system comprising:
a fluid supply channel provided in the rotor shaft;
a plurality of groups of fluid flow-out channels arranged on the rotor shaft and corresponding to the stator coil; and
a fluid storage channel provided at the middle part of the rotor shaft and in fluid communication with the fluid supply channel and the fluid flow-out channels,
wherein the fluid supply channel is adjacent to at least one of the plurality of groups of fluid flow-out channels and at least partially extends into the fluid storage channel, so that the cooling fluid flowing out of the fluid supply channel enters the fluid storage channel and then flows out of the fluid flow-out channel to cool the stator coil.

2. The motor according to claim 1, wherein the plurality of groups of fluid flow-out channels comprise a first group of fluid flow-out channels and a second group of fluid flow-out channels, which are respectively arranged at the positions of the two ends of the rotor shaft corresponding to the stator coil.

3. The motor according to claim 2, wherein the rotor shaft comprises a hollow cylindrical body, a first part and a second part on both sides of the cylindrical body, and the cylindrical body comprises an inner wall, an outer wall, and the plurality of groups of fluid flow-out channels throughout the inner wall and the outer wall; and
the inner wall between the first group of fluid flow-out channels and the second group of fluid flow-out channels is provided with a groove portion to form the fluid storage channel;
wherein the fluid supply channel is inserted into the first part and at least partially extends beyond the first group of fluid flow-out channels in the direction of the rotation axis, so as to enter the fluid storage channel.

4. The motor according to claim 3, wherein the fluid supply channel extends in the direction of the rotation axis no more than ⅓ of the length of the cylindrical body.

5. The motor according to claim 3, wherein inlets of the first and/or second group of fluid flow-out channels are radially inward with respect to the inner wall between the first and second group of fluid flow-out channels.

6. The motor according to claim 5, wherein a step is provided on the inner wall of the cylindrical body between the first group of fluid flow-out channels and the second group of fluid flow-out channels, and close to the first group of fluid flow-out channels and the second group of fluid flow-out channels, respectively, to form the groove portion.

7. The motor according to claim 5, wherein the inner wall of the cylindrical body at the first group of fluid flow-out channels and the second group of fluid flow-out channels is an inclined surface.

8. The motor according to claim 3, wherein the first group of fluid flow-out channels and/or the second group of fluid flow-out channels extend at an angle with respect to the rotation axis.

9. The motor according to claim 8, wherein the first group of fluid flow-out channels comprises a plurality of first guide holes adjacent to the first part, the second group of fluid flow-out channels comprises a plurality of second guide holes adjacent to the second part, and the first guide holes and/or the second guide holes are circumferentially arranged along the rotor shaft.

10. The motor according to claim 9, wherein the first guide holes and/or the second guide holes extend in a radial direction perpendicular to the rotation axis.

11. The motor according to claim 9, wherein the first guide holes and/or the second guide holes extend at an angle to the radial direction perpendicular to the rotation axis.

12. An electric drive assembly system, comprising:
a housing; and
the motor as claimed in claim 1,
wherein the rotor shaft is supported in the housing by at least one bearing.

13. The electric drive assembly system according to claim 12, further comprising:
a gear shaft rotationally fixedly connected with the rotor shaft, the gear shaft comprising a first end and a second end opposite to each other, and a fluid channel throughout the first and second ends, wherein the second end is formed as the fluid supply channel.

14. The electric drive assembly system according to claim 13, further comprising:
a nozzle arranged at the first end and is in fluid communication with the fluid channel, and the nozzle is in clearance fit with the fluid channel.

15. The electric drive assembly system according to claim 14, wherein at the outlet of the nozzle, the fluid channel is provided with a stepped hole, and an inner diameter of the stepped hole is smaller than a radial dimension of the fluid channel and larger than an inner diameter of the nozzle orifice.

16. The electric drive assembly system according to claim 15, further comprising a bearing support structure for the rotor shaft and the gear shaft, wherein the rotor shaft comprises a hollow cylindrical body and a first part and a second part at both sides of the cylindrical body, wherein the bearing support structure comprises:
a first bearing supporting the gear shaft at the first end;
a second bearing supporting the rotor shaft at the first part; and
a third bearing supporting the rotor shaft at the second part.

17. A vehicle comprising the electric drive assembly system according to claim 12.

18. A method for cooling a motor, comprising:
cooling a stator coil by a cooling system to supply fluid to the stator coil of a stator via a rotor shaft of a rotor, wherein the cooling system comprises a fluid supply channel arranged in the rotor shaft; a plurality of groups of fluid flow-out channels arranged on the rotor shaft and corresponding to the stator coil; and a fluid storage channel provided at the middle part of the rotor shaft and in fluid communication with the fluid supply channel and the fluid flow-out channels,
wherein the fluid supply channel is adjacent to at least one of the plurality of groups of fluid flow-out channels, and at least partially extends into the fluid storage channel, so that the cooling fluid flowing out of the fluid supply channel enters the fluid storage channel, and after the cooling fluid fills the fluid storage channel, it flows out of the fluid flow-out channels to cool the stator coil.

19. The method according to claim 18, wherein the plurality of groups of fluid flow-out channels comprises a first group of fluid flow-out channels and a second group of fluid flow-out channels, which are respectively arranged at the positions of both ends of the rotor shaft corresponding to the stator coil; the first group of fluid flow-out channels and/or the second group of fluid flow-out channels extend at an angle relative to the rotation axis of the rotor shaft.

20. The method according to claim 19, wherein an inner wall between the first group of fluid flow-out channels and the second group of fluid flow-out channels is provided with a groove portion to form the fluid storage channel.
